(19) United States
(12) Patent Application Publication
(10) Pub. No.: US 2011/0213734 A1
(43) Pub. Date: Sep. 1, 2011

(54) World retaliation protection project or service or system (WRPP or RWPP or RPS or retaliation protection)

(76) Inventor: Kanal Van Gaston, Kingwood, TX (US)

(21) Appl. No.: 12/931,826

(22) Filed: Apr. 30, 2011

Related U.S. Application Data
(60) Provisional application No. 61/338,810, filed on Feb. 24, 2010.

(51) Int. Cl. G06Q 99/00

(52) U.S. Cl. 705/500

(57) ABSTRACT

A process or method for providing complete and/or lifetime economic, emotional, and physical protection or support to people who suffer or become victims of retaliation (persecution) because they have reported corruption, abuse, incompetence, fraud, mismanagement or any other unlawful or pervasive activities in governments and businesses across the globe (world). This process or method will use all aspects of laws & regulations, telecommunications & technologies, the internet & computer programs, finance & accounting, satellites & databases, and human assets & social engineering.

### BACKGROUND OF THE INVENTION

1. This invention started in 2004 as a result of a desperate search for solutions to incompetence, abuses, fraud, corruption, mismanagement, and all other unlawful or pervasive activities, which take place daily in governments and businesses across the globe. Rigorous research and observations conducted by this Inventor clearly show that “FEAR OF RETALIATION/PERSECUTION” from incompetent and corrupt managers or bosses or leaders or people in power at the work place or in businesses and governments has been the main cause of every evil act and man-made calamity or disaster ever experienced by mankind.

2. The present invention is based on significant and intensive research and observations made while performing auditing and forensic (fraud) accounting work of all aspects of businesses and governments (domestically & internationally). These researches and observations show that both current or past whistle-blower laws and civil rights laws do not work and do not provide any practical protection to any citizen or Courageous Persons (CP) who have ever reported corruptions. These current laws serve absolutely no purpose whatsoever other than protecting the rich & powerful while providing cover to the same corrupt perpetrators and their cronies with whom they have shown many favors.

3. Accordingly, the only solution to good governments and proper or ethical business practices or activities across the globe is to “remove this (reporting) fear” by providing lifetime economic, emotional & physical support or protection to all citizens who are retaliated against or have been falsely accused or persecuted or prosecuted, simply because these citizens have reported incompetence and corruption inside those businesses and governments (primarily nonmilitary). And, this invention will do just that!

### SUMMARY OF THE INVENTION

1. This invention involves a constellation of high integrity individuals using all aspects of technologies, telecommunications, and multiple subject matters to help bring an end to incompetence, abuse, fraud, mismanagement, corruption, and all other unlawful or pervasive activities in governments & businesses across the globe. This process or method will remove the common fear normally associated with the consequences or negative impacts of retaliation on working citizens by providing them with:
(a) Income & Benefit Protection
(b) Personal Identity Protection
(c) Employment & Education Verification

2. This invention clearly helps to correct the horrendous level of inequity in the justice and economic systems of the world whereby the pervasive or incompetent and corrupt decisions of a few bad managers or leaders in governments & businesses could actually min the lives of the remaining six billion people living on planet earth. In other words, this invention provides a true voice, real protection, and equity to the powerless citizenry against the rich and the powerful few of our world.

### DETAILED DESCRIPTIONS OF THE INVENTION

Income & Benefit Protection
A. Instead of “whistle blower,” citizens who now report incompetence, abuse, fraud, mismanagement, corruption, and other unlawful or pervasive activities in governments & businesses across the globe will be called “Courageous People or Persons (CP).” This is the highest honor a citizen can earn in any country or in any of God's Books.
B. To trigger the full benefits and immediate protection of this invention, a courageous citizen simply needs to the following:

1. Report to a supervisor or manager or any official of a business or a government any instance of incompetence, mismanagement, abuse, fraud, corruption, or any other unlawful or pervasive activities within that particular entity or elsewhere, which first gives them the opportunity to correct the condition or problem and/or make amends.

2. Officially and properly informs or notifies WRPP or this invention's network that s/he reported the above condition or behavior to a manager or supervisor or any official.

3. The business or government, through its managers or supervisors or any others in power, decides to retaliate against the citizen (e.g. change of work schedule, undesirable assignments, subjective & lower performance ratings, lower or no bonus, sudden negative or fabricated opinions or references about job performance, or lower or no raises after the citizen exposed the condition).

4. WRPP uses a simple formula to determine any sign of retaliation; this simply involves comparing the Courageous Citizen's most recent employment activities or records prior to reporting or exposing the condition to that after s/he reported or exposed the condition. Any significant negative changes as listed above will cause WRPP to move in quickly to protect this Citizen's interests or well-being fully, whether s/he has resigned (constructively=forced to resign) or has been terminated as a direct result of the retaliation.

5. If the Courageous Citizen does not want to resign despite of the retaliation, WRPP simply provides the courageous citizen with his/her own lawyer who will work with him or her and/or with the business or government to fully satisfy the Courageous Citizen's employment needs or concerns. But, if the courageous citizen resigned or was terminated as a result, WRPP will immediately begin to make direct payroll deposit to the Courageous Citizen's bank account after s/he has received his/her last payroll check from the employer.

6. WRPP will also immediately restore all of the Courageous Citizen's benefits up to a certain amount annually for the next 99 years until his/her death, whichever occurs first, leaving the Courageous Citizen and his/her family with an absolute stream of income or health benefits that no one else can ever take away.

7. WRPP will also make it possible for all Courageous Citizens to use their experiences & knowledge to teach other people about important & relevant societal issues at least about 20 hours per week. However, this may be possible only if the Courageous Citizen does not or will not hold full time employment elsewhere after the retaliation. However, if the Courageous Citizen decides to hold employment elsewhere after the retaliation against him/her, WRPP will only pay him/her the difference between what s/he currently makes and what s/he was making before the retaliation, up to a certain amount.

Personal Identity Protection
A. Because it is virtually impossible to keep other people from knowing our personal and professional information, to give peace of minds to the citizenry, the process or method in this invention is designed to make it almost impossible for anyone who might be in possession of another citizen's personal or private information to use such information for their own personal gain or benefit, at least NOT without the innocent citizen or victim knowing about it before hand. From the hands of a cell phone company worker to the hands of the clerk at our doctor's office, everyone is pretty much compelled to provide his/her personal information practically everywhere s/he goes.

Here is how it works!

1. The way the bad guy normally steals an innocent person's identity or personal information is (a) by using the victim's information to obtain credit or certain benefits and (b) by misusing the innocent person's credit cards to purchase goods or services, and have such cards or goods delivered to a remote location different than the victim's address. Therefore, the only way to put these bad guys out of business is to prevent them from having goods purchased with debit or credit cards delivered to locations not listed in the account owners' addresses or elsewhere. And, WRPP will do just that.

2. A second way to prevent identity theft is to alert a potential victim or citizen or the true person, (by text or phone call or email) before the institution approves and sends out the credit cards or goods or benefits. Much better, if the address on the citizen's credit file or record is different from the address on the application for benefit or credit, this application will be denied automatically altogether.

3. With the permission or consent of a courageous citizen or person, WRPP will establish a special relationship with the major credit bureaus, financial institutions, businesses, and other appropriate entities to ensure that a Courageous Citizen receives immediate or instantaneous text and email notifications directly to his cell phone & email, whenever an application for credit or request for any benefit is made under the Citizen's name for goods or services or before the transaction takes place, especially for those big ticket items or high limit credit cards to be delivered at a remote location in the world.

4. This service will not only put the potential victim or citizen in charge of his/her own credit or personal record wherever s/he might be in the world, but it will also give the citizen an opportunity to instantaneously or immediately reject transactions or applications that appear fraudulent while accepting those that are legitimate. With a simple ‘yes’ or ‘no’ confirmation or by simply pressing “1” for yes and “2” for ‘no’ on a keypad or screen, the citizen will be on his way to fully taking charge & protecting his/her accounts & the use of his identity everywhere in the world.

5. In other words if a citizen did not originate a transaction or credit application, it will simply get rejected, but if the citizen recognizes or originated the transaction, it will proceed through the normal process. Unlike other services, which alerts citizens after the misuse of your identity, this invention or service will alert the citizen before any misuse takes place, therefore giving the Citizen an opportunity to prevent or stop such misuses all together.

6. This service is not only unique, but may also represent the only solution to identity theft that financial institutions, businesses, governments, and citizens across the globe have been longing for decades. This simple system can save these institutions and consumers hundreds of billions of dollars in losses related to credit card fraud and identity theft.

Employment & Education Verification
A. The researches and observations used to develop this invention clearly show that the way a corrupt and incompetent manager stays in business and get his sweet revenge against a Courageous Citizen who exposed the managers' corruption is by using “the phone call in the dark” or the “employment verification check.” The employment verification check, whereby a manager or officer from one organization calls another manager in another organization to verify the employment information of a prospective employee, is the most corruptive and pervasive process of all business activities. This process is responsible for the ruining and the destroying of more innocent lives than any war has ever caused. Yet, most citizens are unaware of this.

Example A:

1. For ages now, corrupt and incompetent managers have well been aware of existing laws or regulations often designed to prohibit them from engaging in certain unlawful or pervasive activities at the work place. To bypass those regulations or laws, they have simply instilled fear of job loss and career sabotage in any honest or decent employee who might have the slightest beat of desire and courage to come forward and report the corrupt and unlawful activities of these managers or officials, especially during tough economic times. They call it “don't burn your bridges.”

2. In fact, there are millions of extremely well-qualified job applicants today who have sought and continue to seek employment with many organizations, but have never even received a phone call back. Yet, these poor souls will never know that it was actually their previous employers or managers and former jealous coworkers or so-called friends who had sabotaged these prospective job opportunities for them, through the currently brutal, inhumane, and completely worthless process of employment verification & reference checks. However, the prospective employer itself becomes the victim in actuality, for missing the opportunity to hire the best candidate for the job simply because of false and bias opinions.

Example B:

1. Let's say, during the past seven years you have worked for a major financial firm in New York with a six figure salary and a large family to feed. And, one day, while reviewing the company's books and records, you suddenly realize that your boss or manager has been involved in some major PONZI scheme costing the general public or investors billions of dollars. The question is: would you report this? Better yet, to whom? Although in theory it might sound nice to say “yes.” However, in practice or reality the answer is almost always “no.” This is understandable! First of all, other than a very corrupt few, most citizens living today do not have the time or the interest to even try to understand how basic accounting, finance, & computer applications work. And yet, knowledge in these three areas is what drives the entire current world economy.

2. A better question is: how can you expect another human being to jeopardize his livelihood to protect and save yours, when you are not even going to be around to help pick him up when he falls flat on his butt, with no jobs or no means of supporting his own families? Corrupt managers know that sooner or later employees are going to seek employment elsewhere. And, they also know that these employees would have no chance of getting any new jobs without first showing to the new employer past work experience & references. Since employers today have no other means of verifying work experience other than making a phone call to your previous manager and jealous coworkers, it is at this very point or juncture that the corrupt manager or jealous coworker lays the big one on you (settle old scores or bigotry or hatreds against you), simply because you had either refused to participate in their corrupt activities in the past or you had refused to kiss their butts for favors or simply because you worked harder and performed better than they did at the work place.

Example C:

1. Even if any courageous employee wanted to report a fraud scheme or corruption in corporations or governments, no one would listen to him anyway. Not the regulators, not the authorities, not the investors themselves who love to enjoy their temporary short gains, and not even the public whom they are trying to protect. Comparing to a CEO or CFO title, the status of a regular employee such as inspector or auditor or analyst is generally considered too small and insignificant to merit a full-ear or the attention of the uninformed citizenry, who are the same & the first people to cry for help when man-made disasters hit. And, this is why so many people are fooled and deceived every day. The gigantic or iconic and reputable CEO or manager who hired tons of people, donated tons of money to charities, and attend Sunday church services in a community are generally too important to be touched or simply ‘too big to fail.’

Solutions!

1. The employment verification process was not designed to be used by incompetent and corrupt managers to retaliate or settle old scores with innocent and courageous employees. This process was designed to provide a prospective employer with the true and accurate record of a current or former employee in order to determine whether an applicant has the work experience and/or education necessary to perform the duties in a new job. For these reasons, WRPP also designed a new Employment Verification System or Service (EVS) whereby prospective employers will no longer need to call former employers or supervisors or managers or human resource departments in order to obtain accurate employment information on both current and former employees. This method involves having an online access whereby any business in the world, with the permission of an employment candidate as provided in the employment application, will be able to pull the actual academic and employment records of that candidate in one single place, thereby determining the candidate's qualifications on the spot.

2. Since virtually all legitimate companies and certainly all educational higher institutions in the modern world has a web site today, all a prospective employer has to do is the following:
a. Log into WRPP's web site with the candidate's consent and social security number.
b. Simply print the dates of employment and duties/position or any other relevant information from a job candidate's previous and current employers, along with the candidate's diplomas or proof of education and graduation from any educational institutions in the modern world. Only partial or the last four-digits of the candidate's social security number or identifiable information will be shown on the printed record. Bingo!

3. With these two pieces of information along with any applicable criminal background checks, a prospective employer should be able to make its hiring decision without bias or speaking with a single person who may be corrupt or jealous with bias opinions against a job candidate. Documents don't lie, but people generally do either to protect their selfish interests or simply because of bribes or jealousy of another more accomplished person.

### CONCLUSION

This invention is unprecedented in the history of mankind because it will totally revolutionize world markets or the way society does businesses. It will serve as a major pathway to proper and ethical business practices, and provide true economic freedom for all citizens of the world. This invention will eradicate the FEAR of retaliation/persecution currently experienced by all Courageous Citizens or People (CP) who want to come forward and report abuses, corruption, mismanagement, fraud, and any other unlawful or pervasive activities, which take place daily in governments and businesses across the globe. The method or process in this invention will provide complete and/or lifetime economic, emotional, and physical protection or support to these Courageous People, using all aspects of laws & regulations, telecommunications & technologies, the internet & computer programs, finance & accounting, satellites & databases, and human assets & social engineering. More specifically, the methods or processes in this invention will provide for these citizens lifetime:
1. Income & Health Benefits Protection
2. Personal Identity Protection
3. Employment & Education Verification (Protection)

1. A process or method for providing complete and/or lifetime economic, emotional, and physical protection or support to people who suffer or become victims of retaliation (persecution) because these individuals have reported corruption, abuse, incompetence, fraud, mismanagement or any other unlawful or pervasive activities in governments and businesses across the globe (world). This process or method will use all aspects of laws & regulations, telecommunications & technologies, the internet & computer programs, finance & accounting, satellites & databases, and human assets & social engineering.

2. The process or method according to claim 1, is designed to make it almost impossible for anyone who might be in possession of another citizen's personal or private information to misuse such information for their own personal gain or benefit. The process or method will instantly notify or alert the citizenry (via text, call, email etc.) before his/her information is misuse for any or all or certain designated or desired level of business purposes, thereby instantly giving the citizenry the option to accept authorized business or personal transactions and/or reject unauthorized ones.

3. The process or method according to claim 1, is also designed with a new Employment Verification System or Service (EVS) whereby prospective employers will no longer need to call former employers or supervisors or managers and/or human resource departments in order to obtain accurate employment information on both current and former employees. This process or method has online access whereby any business in the world, with the permission of an employment candidate as provided in an employment application, will be able to pull the actual academic and employment records of any candidate in one place, securely online or by fax without any form of human bias.
